(19) United States
(12) Patent Application Publication
(10) Pub. No.: US 2026/0312897 A1
(43) Pub. Date: Oct. 8, 2026

(54) CHANNEL UTILIZATION AS THROUGHPUT BOTTLENECK INDICATOR

(71) Applicant: Ekahau, Inc., New York, NY (US)

(72) Inventors: Olli Alanen, Helsinki (FI); Teemu Pulkkinen, Helsinki (FI); Janne Kurjenniemi, Jyväskylä (FI)

(21) Appl. No.: 19/098,370

(22) Filed: Apr. 2, 2025

(51) Int. Cl. H04L 43/0882; H04L 43/0888

(52) U.S. Cl. CPC H04L 43/0882; H04L 43/0888

(57) ABSTRACT

The devices, systems, and methods described herein are directed to measuring a channel utilization value of a connection between a network and a client device during a connection evaluation procedure performed on the connection. In some examples, a first channel utilization value of the connection is measured during a first phase of the connection evaluation procedure, and a second channel utilization value of the connection is measured during a second phase of the connection evaluation procedure. In further examples, a backhaul of the network is determined as limiting traffic throughput of the connection, when the channel utilization value is below a threshold value, and a Wi-Fi portion of the connection is determined as limiting traffic throughput of the connection, when the channel utilization value is at or above the threshold value.

### FIELD

The subject matter described herein relates to connection analysis and more particularly to performing a bottleneck analysis of a connection.

### BACKGROUND

Wi-Fi is a family of wireless network protocols based on the Institute of Electrical and Electronics Engineers (IEEE) 802.11 family of standards, which are commonly used for local area networking of devices and Internet access, allowing nearby digital devices to exchange data via radio waves. Wi-Fi networks are some of the most widely used computer networks in the world, used globally in home and small office networks to link devices together and to connect them to the Internet via a wireless router. Wi-Fi networks often use wireless access points in public places like coffee shops, hotels, libraries, and airports to provide visitors with Internet connectivity for their mobile devices. In some instances, one or more access points of a Wi-Fi network are connected to a wired network by a backhaul connection, which provides connectivity from the wired network to the Wi-Fi network.

### SUMMARY

The devices, systems, and methods described herein are directed to measuring a channel utilization value of a connection between a network and a client device during a connection evaluation procedure performed on the connection. In some examples, a first channel utilization value of the connection is measured during a first phase of the connection evaluation procedure, and a second channel utilization value of the connection is measured during a second phase of the connection evaluation procedure. In further examples, a backhaul of the network is determined as limiting traffic throughput of the connection, when the channel utilization value is below a threshold value, and a Wi-Fi portion of the connection is determined as limiting traffic throughput of the connection, when the channel utilization value is at or above the threshold value.

### BRIEF DESCRIPTION OF THE DRAWINGS

FIG. 1 is a block diagram of a first example of a system for performing a bottleneck analysis of a connection. The system includes a measurement device and a computing device to perform the analysis.

FIG. 2 is a block diagram of an example of the measurement device shown in FIG. 1.

FIG. 3 is a block diagram of a second example of a system for performing a bottleneck analysis of a connection in which the measurement device is integrated into the computing device.

FIG. 4 is an example in which the channel utilization value of a connection between a network and a client device is measured during a first phase and a second phase of a speed test performed on the connection.

FIG. 5 is an example of how the measured channel utilization values of the connection between the network and the client device would look when the Wi-Fi portion of the connection is limiting throughput in both the first phase and the second phase of the speed test shown in FIG. 4.

FIG. 6 is an example of how the measured channel utilization values of the connection between the network and the client device would look when the Wi-Fi portion of the connection is not limiting throughput in either the first phase or the second phase of the speed test shown in FIG. 4.

FIG. 7 is an example of how the measured channel utilization values of the connection between the network and the client device would look when the Wi-Fi portion of the connection is not limiting throughput in the first phase but is limiting throughput in the second phase of the speed test shown in FIG. 4.

FIG. 8 is an example of how the measured channel utilization values of the connection between the network and the client device would look when the Wi-Fi portion of the connection is limiting throughput in both the first phase and the second phase of the speed test shown in FIG. 4, yet the channel utilization was high before the speed test was initiated.

FIGS. 9A and 9B include a flow chart of an example of a method for performing a bottleneck analysis of a connection.

### DETAILED DESCRIPTION

Since Wi-Fi networks are very widely deployed in different environments, it is desirable to be able to determine the location of bottlenecks in the connection between a network and a client device so that system configurations can be adjusted, if necessary, to reduce or eliminate the identified bottleneck. In some examples described herein, the connection between the network and a client device includes a backhaul of the network and a Wi-Fi portion of the connection (e.g., between a wireless access point of the network and the client device). In further examples, the backhaul may include a wired connection and/or a wireless connection.

Bottleneck analysis typically requires network connectivity, route tracing, and performance measurements between individual links. The individual links should be measured separately by (1) running a tool that measures the speed or maximum achievable bandwidth of a connection with a client device connected via Wi-Fi, and (2) running a tool that measures the speed or maximum achievable bandwidth of a connection within an access point or on the wired network with a separate computer. However, it is usually not possible to run a tool that measures the speed or maximum achievable bandwidth of a connection within an access point. Thus, typical bottleneck analysis is difficult, time-consuming, and inefficient.

The examples described herein may advantageously simplify and improve bottleneck analysis by performing the analysis based on channel utilization indicators, which allows the analysis to be performed wirelessly, without the measurement device connecting to the target network or participating in the actual network topology.

As background for the examples described herein, it should be appreciated that the Wi-Fi standard has been engineered to be tolerant to interference and signal degradation issues. This tolerance ensures that the Wi-Fi connection remains viable at a wide range of data rates. Thus, the effect of degradation of the network link (e.g., backhaul) is mainly apparent in the decrease of the effective data rate of the Wi-Fi connection. In practice, this means that as long as the network structure (e.g., backhaul) behind the wireless network has capacity, Wi-Fi will try to maximize the available bandwidth.

Thus, the Wi-Fi channel use will be maximized regardless of the actual data rate that is achieved. For example, a lower data rate employs a simpler modulation scheme when transmitting data, which has the effect of using more time to accomplish the same amount of data transfer. In other words, the percentage of the Wi-Fi channel in use (e.g., “channel utilization”) largely remains constant while the complexity of the modulation scheme and the effective data rate may change. The exception to this rule is if the backhaul limits the traffic of the connection, in which case unused capacity in the Wi-Fi channel remains, which lowers the channel utilization. This intuition can be used to determine the location of a bottleneck in the connection between the network and a client device by simply monitoring the channel utilization.

In some examples, the backhaul of the network is identified as a bottleneck that is limiting traffic throughput of the connection. In other examples, the Wi-Fi portion of the connection is identified as a bottleneck that is limiting traffic throughput of the connection. In further examples, both the backhaul of the network and the Wi-Fi portion of the connection are identified as bottlenecks that are limiting traffic throughput of the connection.

In still further examples, the channel utilization can differ based on the source of information. At a serving radio (e.g., in an access point of the network), the radio frequency (RF) environment can differ greatly from the RF environment at the location of a client device. Regardless, the utilization of the link between the serving radio and the client device is determined by the more congested environment, which dictates the type of modulation that can be achieved. Thus, in some examples, the concept of link utilization can be further utilized to perform the bottleneck analysis. For example, a “combined link utilization value” refers to the higher of a first channel utilization value (e.g., “Basic Service Set (BSS) load”) measured by a serving radio and a second channel utilization value measured at the client device, in some examples. However, in other examples, any other suitable combined link utilization value may be utilized so long as the value takes into account a combination of the utilization experienced at the serving radio and the client device. In some examples, link utilization may provide a more holistic view of the network link than the channel utilization metric, which may primarily describe a local view of the traffic from one of the parties participating in the connection.

The devices, systems, and methods described herein are directed to measuring a channel utilization value of a connection between a network and a client device during a connection evaluation procedure performed on the connection. In some examples, a first channel utilization value of the connection is measured during a first phase of the connection evaluation procedure, and a second channel utilization value of the connection is measured during a second phase of the connection evaluation procedure. In further examples, a backhaul of the network is determined as limiting traffic throughput of the connection, when the channel utilization value is below a threshold value, and a Wi-Fi portion of the connection is determined as limiting traffic throughput of the connection, when the channel utilization value is at or above the threshold value.

Although the different examples of devices, systems, and methods may be described herein separately, any of the features of any of the examples may be added to, omitted from, or combined with any other example. Similarly, any of the features of any of the examples may be performed in parallel or performed in a different manner/order than that described or shown herein.

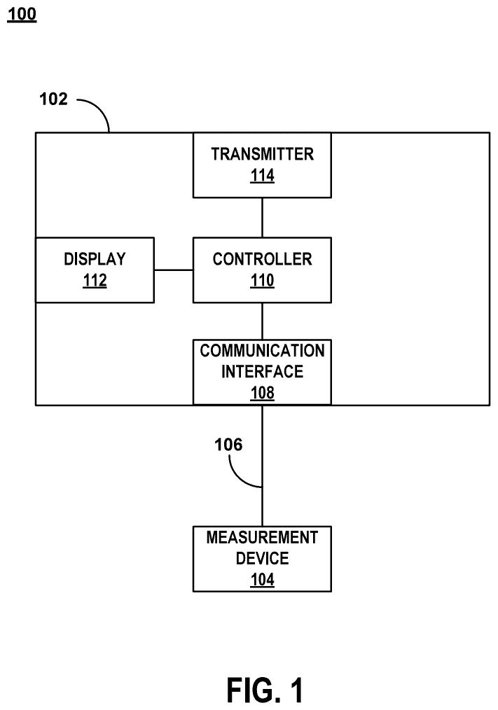

FIG. 1 is a block diagram of a first example of a system for performing a bottleneck analysis of a connection. The system includes a measurement device and a computing device to perform the analysis. In the example shown in FIG. 1, system 100 includes local computing device 102 and measurement device 104. In some examples, local computing device 102 can be any on-site computing device that can receive and process data associated with a wireless network. For example, local computing device 102 could be a tablet computer, a laptop computer, a smartphone, or a desktop computer. In other examples, any other suitable computing device, even a remote, off-site computing device, could be used to perform the functions described herein.

Local computing device 102 includes communication interface 108, controller 110, display 112, and transmitter 114. In operation, local computing device 102 receives data from measurement device 104 via communication link 106. Communication interface 108 enables communication between measurement device 104 and local computing device 102. In the example shown in FIG. 1, communication link 106 is a wired communication link that operates in accordance with at least one of the family of Universal Serial Bus (USB) specifications. In other examples, communication link 106 may operate in accordance with other wired specifications. In further examples, communication link 106 may operate in accordance with any suitable wireless specification (e.g., Bluetooth).

Controller 110 includes any combination of hardware, software, and/or firmware for executing the functions described herein. An example of a suitable controller 110 includes software code running on a microprocessor or processor arrangement connected to memory (not explicitly shown).

Display 112 is used to present information to a user regarding a bottleneck analysis performed by local computing device 102. Display 112 can be used to present a variety of information to the user. In the example shown in FIG. 1, display 112 includes an associated input mechanism (e.g., touchscreen) by which the user can select one or more connections for bottleneck analysis. In some examples, the user can use the input mechanism to select one or more recommended actions to improve traffic throughput, given the results of the bottleneck analysis. In further examples, any other suitable input mechanism may be used (e.g., keyboard, touchpad, mouse, microphone, etc.).

In the example shown in FIG. 1, transmitter 114 includes electronics configured to transmit wireless signals. In some examples, transmitter 114 may include multiple transmitters. In other examples, transmitter 114 may be integrated into measurement device 104 or into a wireless communication device that is part of the wireless network or that is within the coverage area of the wireless network.

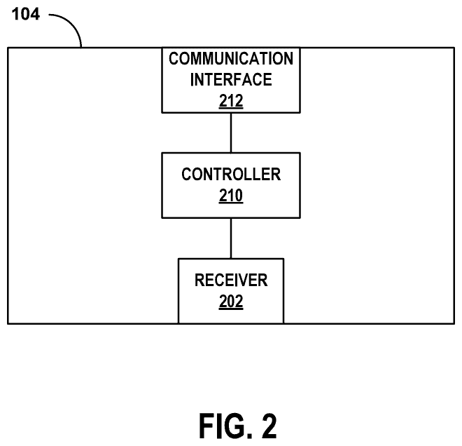

FIG. 2 is a block diagram of an example of measurement device 104 shown in FIG. 1. In the example shown in FIG. 2, measurement device 104 includes receiver 202 to receive Wi-Fi signals from various nodes of a Wi-Fi (e.g., wireless) network. In other examples, any other suitable number of receivers may be utilized in measurement device 104. Regardless of the number of receivers in measurement device 104, each receiver is capable of scanning and monitoring a set of Wi-Fi channels and capturing all Wi-Fi link layer frames (e.g., packets) being heard on those channels, in some examples. In other examples, a single Wi-Fi radio (e.g., receiver), module, or chipset can be configured to operate on the separate channels at the same time, which is referred to as a Dual Band Simultaneous (DBS) configuration. Thus, the functionality of the measurement device, as described herein, may be accomplished with a measurement device having multiple receivers or a single, properly configured receiver.

The measurement device 104 shown in FIG. 2 also includes controller 210, which processes the signals received by receiver 202. Controller 210 includes any combination of hardware, software, and/or firmware for executing the functions described herein. An example of a suitable controller 210 includes software code running on a microprocessor or processor arrangement connected to memory (not explicitly shown). It is worth noting that, in some examples, any of the functions described herein as being performed by controller 110 may be performed by controller 210, and vice versa.

Measurement device 104, as shown in FIG. 2, also includes communication interface 212, which measurement device 104 uses to communicate with local computing device 102 via communication link 106. In some examples, the communication between measurement device 104 and local computing device 102 includes providing data to local computing device 102 and receiving command instructions regarding which connection(s) is/are selected for bottleneck analysis.

In further examples, measurement device 104 may be any fixed, mobile, or portable equipment that performs the functions described herein. The various functions and operations described with reference to measurement device 104 may be implemented in any number of devices, circuits, or elements. Two or more of the functions of the measurement device may be integrated in a single device, and the functions described as performed in any single measurement device may be implemented over several measurement devices. In the interest of brevity, FIG. 1 only depicts one measurement device 104. However, any number of measurement devices may be utilized to receive Wi-Fi signals, in other examples.

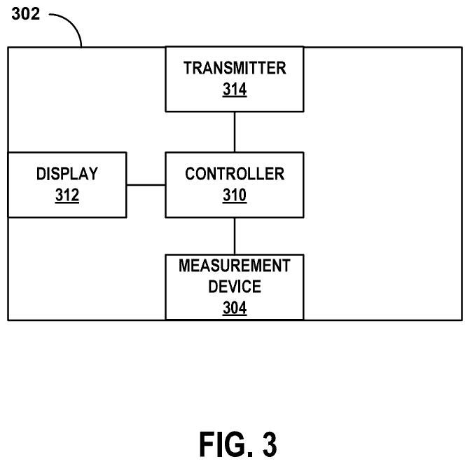

FIG. 3 is a block diagram of a second example of a system for performing a bottleneck analysis of a connection in which the measurement device is integrated into the computing device. In the example shown in FIG. 3, system 302 includes measurement device 304, controller 310, display 312, and transmitter 314. In the example shown in FIG. 3, controller 310 is capable of performing the combined functions of controller 110 and controller 210, as described in connection with FIGS. 1 and 2. Thus, system 302 performs the combined functions of measurement device 104 and local computing device 102, as described herein.

In some examples, measurement device 104 of system 100 is used to receive wireless signals transmitted during a connection evaluation procedure performed on the connection between a network and a client device. In some examples, the connection evaluation procedure is a speed test. In these examples, the speed test measures at least one of the following: a downlink speed of the connection and an uplink speed of the connection. In some examples, the speed test is performed in two phases, one which measures downlink speed of the connection and one which measures uplink speed of the connection.

In other examples, the connection evaluation procedure is a test that determines the maximum achievable bandwidth of the connection. In further examples, the connection evaluation procedure may be any suitable procedure that evaluates one or more characteristics of the connection that can be used to perform the bottleneck analysis.

In some examples, the received wireless signals are used to perform a bottleneck analysis of the connection between the network and the client device. In these examples, a user places measurement device 104 in a location that is proximal to the client device that is an end point of the connection on which the bottleneck analysis is being performed. Thus, measurement device 104 receives the wireless signals transmitted during the connection evaluation procedure performed on the connection between the network and the client device, in some examples.

In the examples in which measurement device 104 receives the wireless signals transmitted during the connection evaluation procedure, measurement device 104 provides data associated with the received wireless signals to local computing device 102 via communication link 106. Based on the data associated with the received wireless signals, local computing device 102 uses controller 110 to measure a channel utilization value of the connection between the network and the client device during a connection evaluation procedure performed on the connection.

In other examples, measurement device 104 receives beacon signals transmitted from the serving radio (e.g., access point). The beacon signals include a Basic Service Set (BSS) Load information element, which includes a channel utilization value based on local measurements taken by the access point.

Thus, in some examples, the channel utilization value is determined by local computing device 102, based on data received from measurement device 104. In other examples, the channel utilization value is obtained from the beacon signals transmitted by the serving radio (e.g., access point).

In some examples, the channel utilization value is expressed as a percentage of the Wi-Fi channel being used during the connection evaluation procedure. In further examples, the channel utilization value is a maximum channel utilization value measured during the connection evaluation procedure. In still further examples, the channel utilization value may be any suitable value derived from the channel utilization measurements taken during the connection evaluation procedure. For example, the channel utilization value may be the mean channel utilization value, the median channel utilization value, or a specified percentile (e.g., 95^{th} percentile) of the measured channel utilization values.

Regardless of whether the channel utilization value is measured by local computing device 104 or obtained from the beacon signals transmitted by the serving radio, controller 110 determines that a backhaul of the network is limiting traffic throughput of the connection, when the channel utilization value is below a threshold value. Likewise, controller 110 determines that a Wi-Fi portion of the connection is limiting traffic throughput of the connection, when the channel utilization value is at or above the threshold value.

In further examples, controller 110 determines a combined link utilization value of the Wi-Fi portion of the connection. In these examples, the combined link utilization value is the higher of a first channel utilization value measured by a serving radio (e.g., and broadcast in a beacon signal) and a second channel utilization value measured at the client device. In still further examples in which a combined link utilization value is determined, controller 110 may also determine that at least one of the backhaul of the network and the Wi-Fi portion of the connection is limiting traffic throughput of the connection, based at least partially on the combined link utilization value of the Wi-Fi portion of the connection.

Although the foregoing discussion mainly focuses on examples in which a single channel utilization value is measured, a separate channel utilization value may be measured during each of a plurality of phases of the connection evaluation procedure, in other examples. More specifically, in some examples, measurement device 104 and local computing device 102 of FIG. 1 may perform a bottleneck analysis of a connection between a network and a client device in which controller 110: measures a first channel utilization value of the connection between the network and the client device during a first phase of a connection evaluation procedure performed on the connection; measures a second channel utilization value of the connection between the network and the client device during a second phase of the connection evaluation procedure performed on the connection; determines that a backhaul of the network is limiting traffic throughput of the connection, when at least one of the first channel utilization value and the second channel utilization value is below a threshold value; and determines that a Wi-Fi portion of the connection is limiting traffic throughput of the connection, when at least one of the first channel utilization value and the second channel utilization value is at or above the threshold value. In some of these examples, the first channel utilization value is a first maximum channel utilization value, and the second channel utilization value is a second maximum channel utilization value. In examples in which the connection evaluation procedure is a speed test, the first phase of the speed test may measure a downlink speed of the connection, and the second phase of the speed test may measure an uplink speed of the connection. Thus, in these examples, the downlink is determined to have a bottleneck in the backhaul of the network when the first channel utilization value, measured during the first phase of the speed test, is below the threshold value, and the uplink is determined to have a bottleneck in the backhaul of the network when the second channel utilization value, measured during the second phase of the speed test, is below the threshold value.

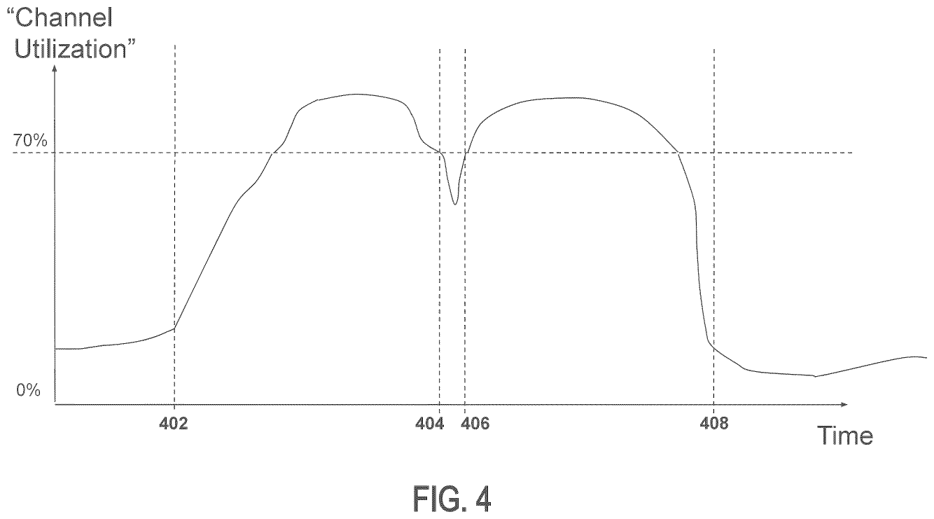

FIGS. 4-8 show graphs of channel utilization values measured over time for some potential scenarios that can be used to determine the location of a bottleneck in a connection between the network and a client device.

FIG. 4 is an example in which the channel utilization value of a connection between a network and a client device is measured during a first phase and a second phase of a speed test performed on the connection. In the example shown in FIG. 4, the first phase of the speed test starts at time 402 and ends at time 404, and the second phase of the speed test starts at time 406 and ends at time 408. The example shown in FIG. 4 has the threshold value set at 70%. Although, in other examples, any suitable threshold value may be used.

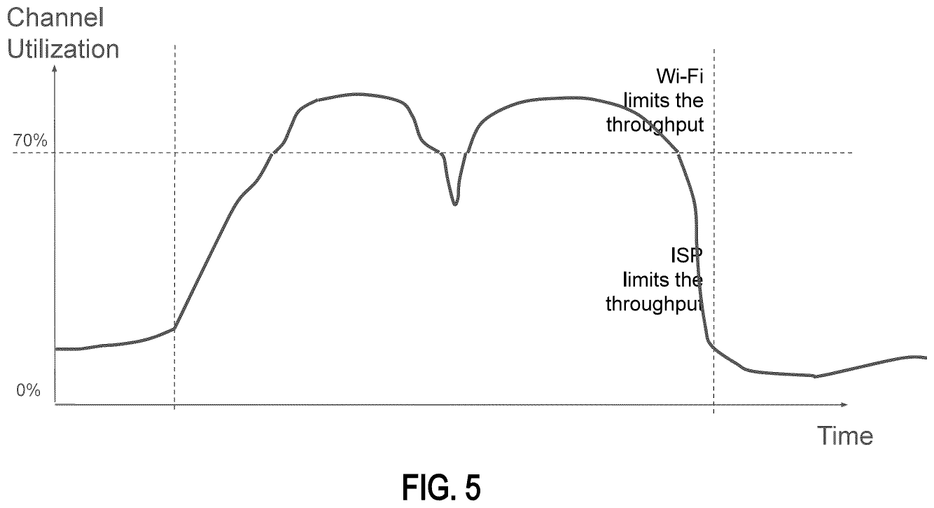

FIG. 5 is an example of how the measured channel utilization values of the connection between the network and the client device would look when the Wi-Fi portion of the connection is limiting throughput in both the first phase and the second phase of the speed test shown in FIG. 4. More specifically, in the example shown in FIG. 5, a first maximum channel utilization value measured during the first phase (e.g., downlink) of the speed test and a second maximum channel utilization value measured during the second phase (e.g., uplink) of the speed test are both above the threshold value of 70%. Since both the first maximum channel utilization value and the second maximum channel utilization value are at or above the threshold value, controller 110 determines that the Wi-Fi portion of the connection is limiting traffic throughput of the connection.

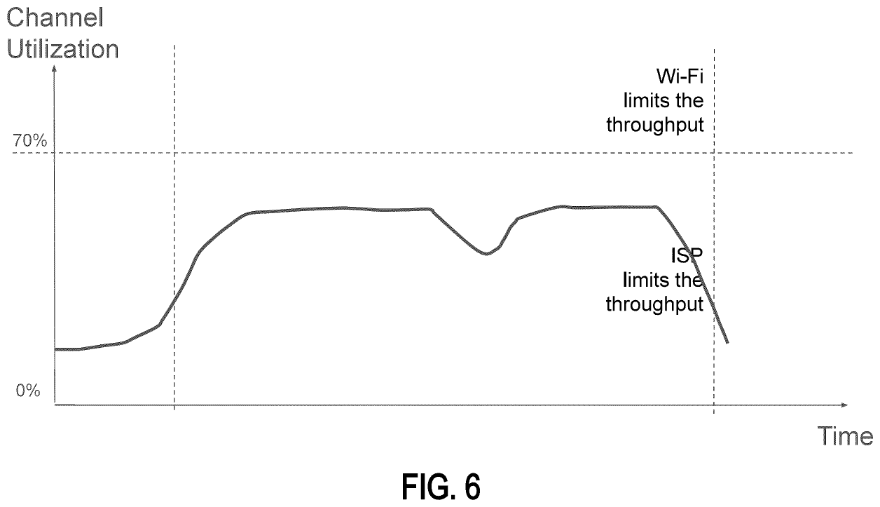

FIG. 6 is an example of how the measured channel utilization values of the connection between the network and the client device would look when the Wi-Fi portion of the connection is not limiting throughput in either the first phase or the second phase of the speed test shown in FIG. 4. More specifically, in the example shown in FIG. 6, a first maximum channel utilization value measured during the first phase (e.g., downlink) of the speed test and a second maximum channel utilization value measured during the second phase (e.g., uplink) of the speed test are both below the threshold value of 70%. Since both the first maximum channel utilization value and the second maximum channel utilization value are below the threshold value, controller 110 determines that a backhaul of the network (e.g. Internet Service Provider (ISP)) is limiting traffic throughput of the connection.

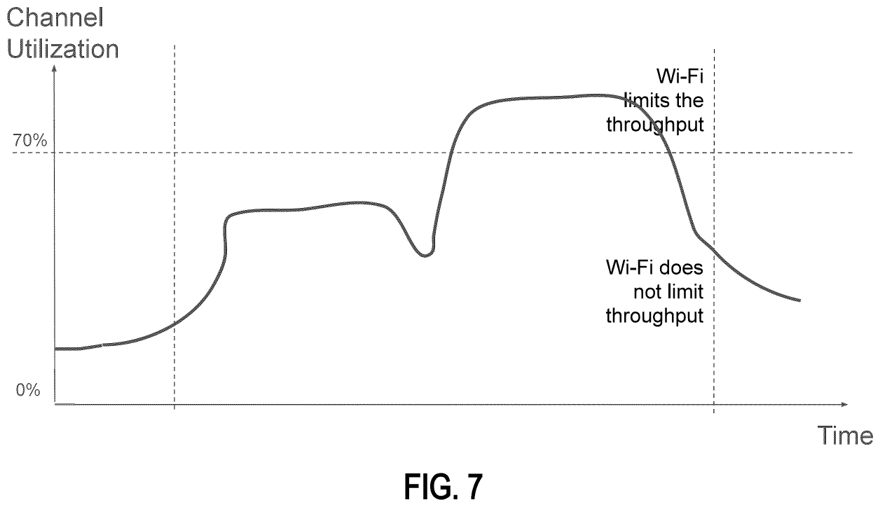

FIG. 7 is an example of how the measured channel utilization values of the connection between the network and the client device would look when the Wi-Fi portion of the connection is not limiting throughput in the first phase but is limiting throughput in the second phase of the speed test shown in FIG. 4. More specifically, in the example shown in FIG. 7, a first maximum channel utilization value measured during the first phase (e.g., downlink) of the speed test is below the threshold value of 70%, and a second maximum channel utilization value measured during the second phase (e.g., uplink) of the speed test is at or above the threshold value of 70%. Since the first maximum channel utilization value is below the threshold value, controller 110 determines that a backhaul of the network (e.g. ISP) is limiting traffic throughput of the downlink transmissions. Since the second maximum channel utilization value is at or above the threshold value, controller 110 determines that the Wi-Fi portion of the connection is limiting traffic throughput of the uplink transmissions. Thus, in this example, the uplink capacity of the backbone may be lower than the downlink capacity of the backbone, which can be common in Digital Subscriber Line (DSL) connections.

Although not explicitly shown, in other examples, the first channel utilization value may be at or above the threshold value, and the second channel utilization value may be below the threshold value. In these examples, since the first maximum channel utilization value is at or above the threshold value, controller 110 determines that the Wi-Fi portion of the connection is limiting traffic throughput of the downlink transmissions. Since the second maximum channel utilization value is below the threshold value, controller 110 determines that a backhaul of the network (e.g. ISP) is limiting traffic throughput of the uplink transmissions.

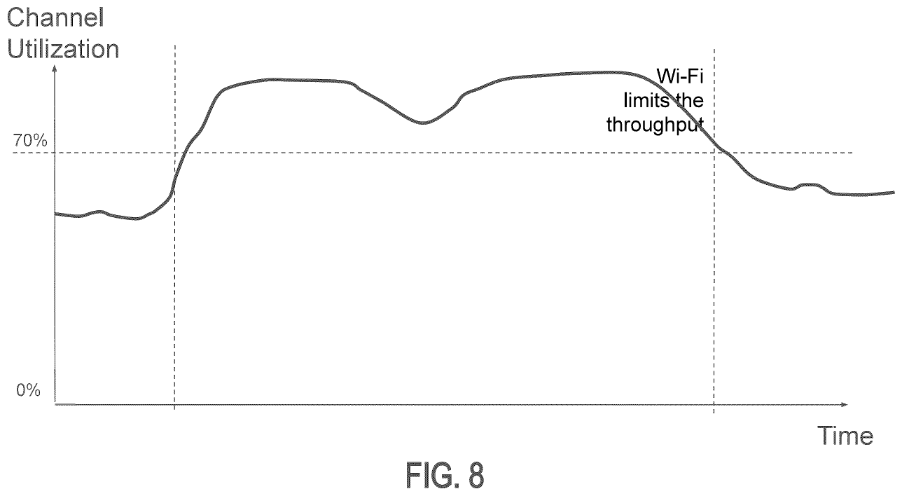

FIG. 8 is an example of how the measured channel utilization values of the connection between the network and the client device would look when the Wi-Fi portion of the connection is limiting throughput in both the first phase and the second phase of the speed test shown in FIG. 4. However, in the example shown in FIG. 8, the speed test is not necessarily causing a bottleneck since the channel utilization (e.g., from other Wi-Fi traffic) was already high before the speed test was initiated. Thus, there may be other users that are utilizing the Wi-Fi channel.

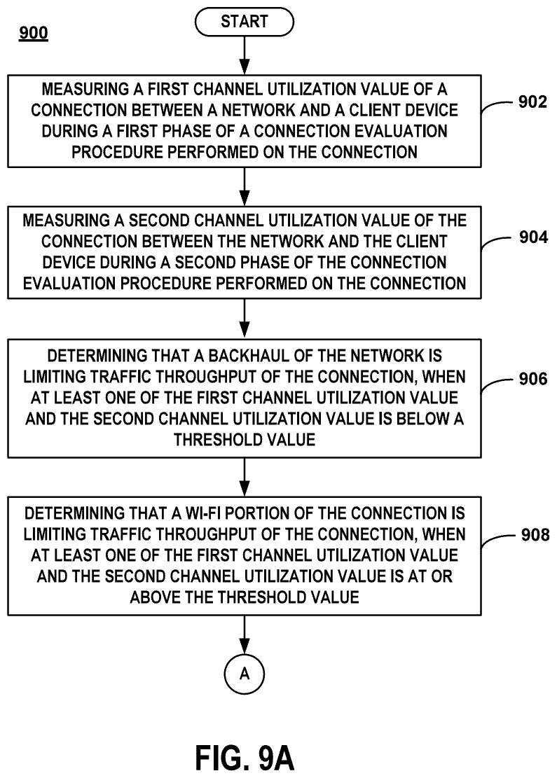

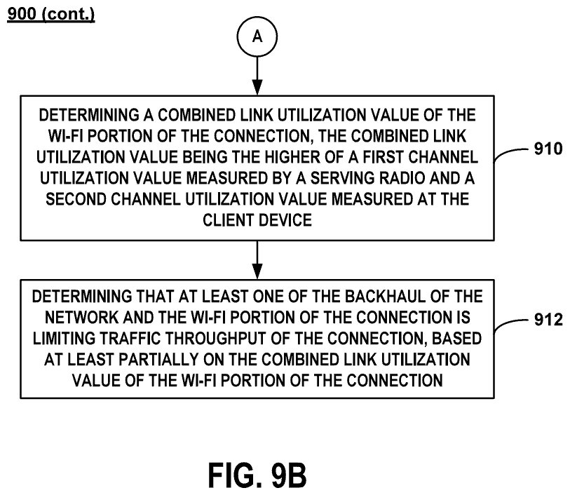

FIGS. 9A and 9B include a flow chart of an example of a method for performing a bottleneck analysis of a connection. The method 900 begins at step 902 with measuring a first channel utilization value of a connection between a network and a client device during a first phase of a connection evaluation procedure performed on the connection. At step 904, the method continues with measuring a second channel utilization value of the connection between the network and the client device during a second phase of the connection evaluation procedure performed on the connection. At step 906, the method further includes determining that a backhaul of the network is limiting traffic throughput of the connection, when at least one of the first channel utilization value and the second channel utilization value is below a threshold value. At step 908, the method also includes determining that a Wi-Fi portion of the connection is limiting traffic throughput of the connection, when at least one of the first channel utilization value and the second channel utilization value is at or above the threshold value. In some examples, the method 900 may end after step 908 or after presenting (e.g., displaying) the results of steps 906 and 908 to a user. In further examples, the method 900 may continue via the pathway labeled “A” in FIGS. 9A and 9B.

In the examples in which the method 900 continues at step 910, the method additionally includes determining a combined link utilization value of the Wi-Fi portion of the connection, the combined link utilization value being the higher of a first channel utilization value measured by a serving radio and a second channel utilization value measured at the client device. At step 912, the method continues with determining that at least one of the backhaul of the network and the Wi-Fi portion of the connection is limiting traffic throughput of the connection, based at least partially on the combined link utilization value of the Wi-Fi portion of the connection.

In other examples, one or more of the steps of method 900 may be omitted, combined, performed in parallel, or performed in a different order than that described herein or shown in FIGS. 9A and 9B. In still further examples, additional steps may be added to method 900 that are not explicitly described in connection with the example shown in FIGS. 9A and 9B.

Clearly, other examples and modifications of the foregoing will occur readily to those of ordinary skill in the art in view of these teachings. The above description is illustrative and not restrictive. The examples described herein are only to be limited by the following claims, which include all such examples and modifications when viewed in conjunction with the above specification and accompanying drawings. The scope of the foregoing should, therefore, be determined not with reference to the above description alone, but instead should be determined with reference to the appended claims along with their full scope of equivalents.

What is claimed is:

1. A device to perform a bottleneck analysis of a connection, the device comprising:
a controller to:
measure a first channel utilization value of a connection between a network and a client device during a first phase of a connection evaluation procedure performed on the connection,
measure a second channel utilization value of the connection between the network and the client device during a second phase of the connection evaluation procedure performed on the connection,
determine that a backhaul of the network is limiting traffic throughput of the connection, when at least one of the first channel utilization value and the second channel utilization value is below a threshold value, and
determine that a Wi-Fi portion of the connection is limiting traffic throughput of the connection, when at least one of the first channel utilization value and the second channel utilization value is at or above the threshold value.

2. The device of claim 1, wherein the first channel utilization value is a first maximum channel utilization value and the second channel utilization value is a second maximum channel utilization value.

3. The device of claim 1, wherein the connection evaluation procedure is a speed test.

4. The device of claim 3, wherein the first phase of the speed test measures a downlink speed of the connection and the second phase of the speed test measures an uplink speed of the connection.

5. The device of claim 1, wherein the first channel utilization value and the second channel utilization value are below the threshold value.

6. The device of claim 1, wherein the first channel utilization value and the second channel utilization value are at or above the threshold value.

7. The device of claim 1, wherein the first channel utilization value is below the threshold value and the second channel utilization value is at or above the threshold value.

8. The device of claim 1, wherein the first channel utilization value is at or above the threshold value and the second channel utilization value is below the threshold value.

9. The device of claim 1, wherein the controller further determines a combined link utilization value of the Wi-Fi portion of the connection, the combined link utilization value being the higher of a first channel utilization value measured by a serving radio and a second channel utilization value measured at the client device.

10. The device of claim 9, wherein the controller further determines that at least one of the backhaul of the network and the Wi-Fi portion of the connection is limiting traffic throughput of the connection, based at least partially on the combined link utilization value of the Wi-Fi portion of the connection.

11. A method of performing a bottleneck analysis of a connection, the method comprising:
measuring a first channel utilization value of a connection between a network and a client device during a first phase of a connection evaluation procedure performed on the connection;
measuring a second channel utilization value of the connection between the network and the client device during a second phase of the connection evaluation procedure performed on the connection;
determining that a backhaul of the network is limiting traffic throughput of the connection, when at least one of the first channel utilization value and the second channel utilization value is below a threshold value; and
determining that a Wi-Fi portion of the connection is limiting traffic throughput of the connection, when at least one of the first channel utilization value and the second channel utilization value is at or above the threshold value.

12. The method of claim 11, wherein the first channel utilization value is a first maximum channel utilization value and the second channel utilization value is a second maximum channel utilization value.

13. The method of claim 11, further comprising:
determining a combined link utilization value of the Wi-Fi portion of the connection, the combined link utilization value being the higher of a first channel utilization value measured by a serving radio and a second channel utilization value measured at the client device.

14. The method of claim 13, further comprising:
determining that at least one of the backhaul of the network and the Wi-Fi portion of the connection is limiting traffic throughput of the connection, based at least partially on the combined link utilization value of the Wi-Fi portion of the connection.

15. A device to perform a bottleneck analysis of a connection, the device comprising:
a controller to:
measure a channel utilization value of a connection between a network and a client device during a connection evaluation procedure performed on the connection,
determine that a backhaul of the network is limiting traffic throughput of the connection, when the channel utilization value is below a threshold value, and
determine that a Wi-Fi portion of the connection is limiting traffic throughput of the connection, when the channel utilization value is at or above the threshold value.

16. The device of claim 15, wherein the channel utilization value is a maximum channel utilization value.

17. The device of claim 15, wherein the connection evaluation procedure is a speed test.

18. The device of claim 17, wherein the speed test measures at least one of the following: a downlink speed of the connection and an uplink speed of the connection.

19. The device of claim 15, wherein the controller further determines a combined link utilization value of the Wi-Fi portion of the connection, the combined link utilization value being the higher of a first channel utilization value measured by a serving radio and a second channel utilization value measured at the client device.

20. The device of claim 19, wherein the controller further determines that at least one of the backhaul of the network and the Wi-Fi portion of the connection is limiting traffic throughput of the connection, based at least partially on the combined link utilization value of the Wi-Fi portion of the connection.
